(19) United States
(12) Patent Application Publication
(10) Pub. No.: US 2012/0290120 A1
(43) Pub. Date: Nov. 15, 2012

(54) Three Axis Desktop Machining Center with a Simplified Mechanism for Low Cost Implementation

(76) Inventors: Douglas Cameron Dayton, Harvard, MA (US); Timothy L. Moulton, Newport, RI (US)

(21) Appl. No.: 13/463,259

(22) Filed: May 3, 2012

Related U.S. Application Data
(60) Provisional application No. 61/481,782, filed on May 3, 2011.

(51) Int. Cl. G05D 3/00

(52) U.S. Cl. 700/160

(57) ABSTRACT

A CNC three-axis desktop machining center and a method of use are provided by an embodiment that includes a means for mechanical control for these three axes by employing two pivoting structural arms that carry a machining head and a work stock fixturing table that in their respective arc motions intersect one another to create an X-Y swept area of interaction equal or greater than the total surface area of the preformed work stock to be machined. The third axis of control, at right angles to the plane described by the intersecting arcs of the two pivoting structural arms, may be comprised of a movable structural table to which one of the two pivoting arms is affixed.

### RELATED APPLICATIONS

This application claims the priority and benefit of U.S. Provisional Application No. 61/481,782, filed on May 3, 2012, the contents of which are hereby incorporated by reference.

### TECHNICAL FIELD

The present disclosure relates to machining equipment, and more specifically to relatively precise, compact and low-cost devices capable of three-dimensional machining under computer control.

### BACKGROUND

Machine shops are generally equipped with reliable and precise instruments for cutting, forming, shaping and otherwise making machined parts (sometimes generically called “machining”). Typical machining instruments are made to be solid and heavy and large relative to the parts being machined in order to maintain maximum dimensional stability and accuracy during work. Moving parts include motors and rotational and linear components so as to translate and rotate the spinning tools over the work surface as required. Any mechanical play or error in controlling the tool would translate into precision errors and other flaws in the resulting work.

Instruments to aid machining of work pieces have been devised for some time, and today computers control high-speed machining instruments to produce high-precision parts used in industry and other applications. In the early 1950's the first milling machine was converted to computer control utilizing punch cards to affect the cutting patterns. Since that time the world has seen a conversion to computer numerical control (CNC) in almost all categories of machining and production manufacturing. CNC machines span the wide range of capability from custom designed machining platforms dedicated to a single production line to customer versions of all-purpose milling machines and lathes that will create prototype parts from software files with production line accuracy. And the low cost and massive computing powers of today's computers make possible standalone CNC machine tools that cost no more today than the manual milling machines of less than thirty years ago.

Even with the advances in CNC technology, the utilization of CNC tools is primarily relegated to the industry professionals of the machining and manufacturing domains. However, CNC tools are now a common part of product development labs, university experimental machine shops and corporate engineering/manufacturing development centers but their utilization still typically requires a multi-thousand dollar outlay to acquire the machine and extensive training for the operators. This fact of relative high cost and the required extensive training denies a huge population of designers and other creative souls the ability to conceive and create three-dimensional objects at will. There is a significant unmet need for three-dimensional (3D) object creation that encompasses a wide spectrum of users ranging from individual students in the design and engineering professions to teachers and students in secondary and trade schools to parents and children that want to create unique toys and other artifacts in their own home.

### SUMMARY

The present invention discloses a new approach to the design of a milling machine that will enable this unfulfilled population of creative persons to acquire their own CNC three-axis desktop machining center at a very low price and with simplified ease of use. This disclosure presents a mechanism integrated into a product, which can be manufactured for hundreds, not thousands, of dollars and is compact and self-contained, requiring only a household wall outlet to provide power and permitting installation anywhere. The machine interface is simple and the preformed work stock selection and tooling are systematized to enable a novice user to successfully create three-dimensional objects with this machine through simple programming and minimal manual interaction.

In an aspect of the invention, a CNC three-axis desktop machining center and a method of use may comprise a means for mechanical control for these three axes by employing two pivoting structural arms that carry respectively a machining head and a work stock fixturing table that in their respective arc motions intersect one another to create a swept area of interaction equal to or greater than the total projected surface area of the preformed work stock to be machined. The third axis of control, at right angles to the axes described by the intersecting arcs of the two pivoting structural arms, may be comprised of a movable structural table to which one or the other of the two pivoting structural arms is affixed at the pivoting joint, that joint moving with the movable table to control the distance between the machining head and the preformed work stock fixturing table. The positioning of both the pivoting arms and the sliding table may be accomplished by utilizing electrical motors that provide angular position control with closed loop feedback. Connection of the motor shaft to the movable structural elements may be accomplished by a number of transmission elements such as direct gearing, linear actuators, cable or belt drives, or others. Each sequential angular motor position may be defined via the algorithms of a computer program and through a sequence of interrelated angular positions of multiple independent motors for the 3 axes move the machining head relative to the preformed work stock to accomplish the 3-dimensional machined volume described by the computer program.

The utilization of two pivoting structural arms to control the position of the machining head within the X-Y work area provides both simplicity and precision, a simple pivot being the least expensive means to achieve high accuracy of positioning, providing a minimal tolerance stack and also minimizing other undesirable effects of conventional X-Y tables. Incorporating a high ratio mechanical connection between motor and the movable structural element permits the utilization of inexpensive DC servomotors or stepper motors as the angular accuracy of the motors need not be as high to achieve good positional accuracy of the mechanism.

Another aspect of the invention discloses provision of a simple and inexpensive tool changing function that is necessary to expedite the machining process and provide for a range of different scale features. The multiple tools may be affixed to a tool carrier that incorporates a means of connection to the machining head and a means of connection to a universal tool holder that is part of the base structure of the CNC three-axis desktop machining center. With computer control of the machining head and unidirectional compliance of the tool holder, the spindle may axially align with the universal tool holder and by modulating the rotational direction and Z axis distance with feedback from the machining head drive motor the tool carrier may be engaged by the universal tool holder to disengage the tool from the machining head spindle or conversely engage a new tool from another location of the universal tool holder.

Another aspect of the invention discloses a means for affixing the preformed work stock to the work stock fixturing table by a simple and accurate mechanism that eliminates the need for the user to have a knowledge of material characteristics or machining tool selection or setup. Each preformed work stock may have locating features that engage with the work stock fixturing table to provide rigid mounting for the preformed work stock to be machined and to register the preformed work stock accurately in a variety of orientations to ensure repeatability and maximum flexibility of the machining operation. The preformed work stock may be encoded with a machine readable identification that may provide information to the computer control software regarding the necessary machining parameters for that specific preformed work stock material.

Another aspect of the invention discloses a chassis and enclosure for the aforementioned mechanical systems that provide safety and cleanliness for the user and environment. The machining process creates debris that may be contained by the chassis and enclosure for the CNC three-axis desktop machining center so that it does not contaminate the surrounding environment. A vacuum debris removal system may be implemented that permits the user to attach an external vacuum system to the debris collection chamber of the CNC three-axis desktop machining center such that the debris is continuously removed by the vacuum suction of a standard household vacuum cleaner. The CNC three-axis desktop machining center may have a safety interlock system whereby the machine will not operate if the safety covers are not in place. These safety covers prohibit the entry of any external element including the hands or other body parts of the user and if the machine is operating and a cover is opened the machine may instantly stop operation.

These and other systems, methods, objects, features, and advantages of the present invention will be apparent to those skilled in the art from the following detailed description of the alternative preferred embodiments and the drawings.

Some embodiments are directed to a system for machining a workpiece, comprising a tool mounted to a first moveable arm that moves in a first plane defined by a rotational degree of freedom; a fixturing table mounted to a second moveable arm that moves in a second plane defined by a rotational degree of freedom; and a linear translator that translates any of said first or second moveable arms along a translational degree of freedom substantially orthogonal to said first and second planes.

Other embodiments are directed to a system for machining a workpiece, comprising a first moveable arm, coupled to a tool, the first moveable arm also coupled to a first pivot so as to be rotatable about a first axis of rotation; a second moveable arm, coupled to said workpiece, the second moveable arm also coupled to a second pivot so as to be rotatable about a second axis of rotation, said second axis of rotation being substantially parallel to said first axis of rotation; respective rotational drivers for said first and second moveable arms controllable so as to rotate said first and second moveable arms with respect to one another and in corresponding substantially parallel planes of motion; and a linear translator coupled to a driver which moves said linear translator to controllably change a distance between said parallel planes of motion of one or both of said moveable arms.

Still other embodiments are directed to a method in a machining instrument for machining a workpiece, comprising preparing a set of machine-readable instructions describing a machining procedure; providing a plurality of control signals corresponding to said instructions to one or more controllable electro-mechanical components of said machining instrument; controllably rotating a first moveable arm attached to a machining tool in an arc in a first plane of motion according to some of said control signals; controllably rotating a second moveable arm attached to the workpiece in an arc in a second plane of motion according to some of said control signals; and linearly translating at least one of said first and second moveable arms with respect to the other so that a distance between said first and second planes is controlled according to some of said control signals.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE DRAWINGS

The invention and the following detailed description of certain embodiments thereof may be understood by reference to the following figures:

FIG. 1 depicts a three-quarter front perspective view of the CNC three-axis desktop machining center depicting primary axes of motion.

FIG. 2 depicts a three-quarter rear perspective view of the CNC three-axis desktop machining center.

FIG. 3 depicts a three-quarter front perspective view of an alternative embodiment of the CNC three-axis desktop machining center.

FIG. 4 depicts a three-quarter end perspective view of an alternative embodiment of the CNC three-axis desktop machining center.

FIG. 5 depicts a three-quarter rear perspective view of an alternative embodiment of the CNC three-axis desktop machining center.

FIG. 6 depicts the plotted workspace created by the mechanical geometry of the CNC three-axis desktop machining center.

FIG. 7 depicts a machining head and universal tool holder for the CNC three-axis desktop machining center.

FIG. 8 depicts a simple tool changing mechanism for the CNC three-axis desktop machining center.

FIG. 9 depicts a three-quarter front perspective view of a simple tool changing mechanism for the CNC three-axis desktop machining center.

FIGS. 10 and 11 depict an assembled and exploded perspective view of the work stock fixturing table for the CNC three-axis desktop machining center.

FIG. 12 depicts an assembled and exploded perspective view of the work stock fixturing table for the CNC three-axis desktop machining center.

FIG. 13 depicts an assembled and exploded perspective view of the work stock fixturing table for the CNC three-axis desktop machining center.

FIG. 14 depicts an assembled and exploded perspective view of the work stock fixturing table for the CNC three-axis desktop machining center.

FIG. 15 illustrates an exemplary block diagram of components of a system as presently disclosed, user interface, and features for carrying out a method accordingly.

### DETAILED DESCRIPTION

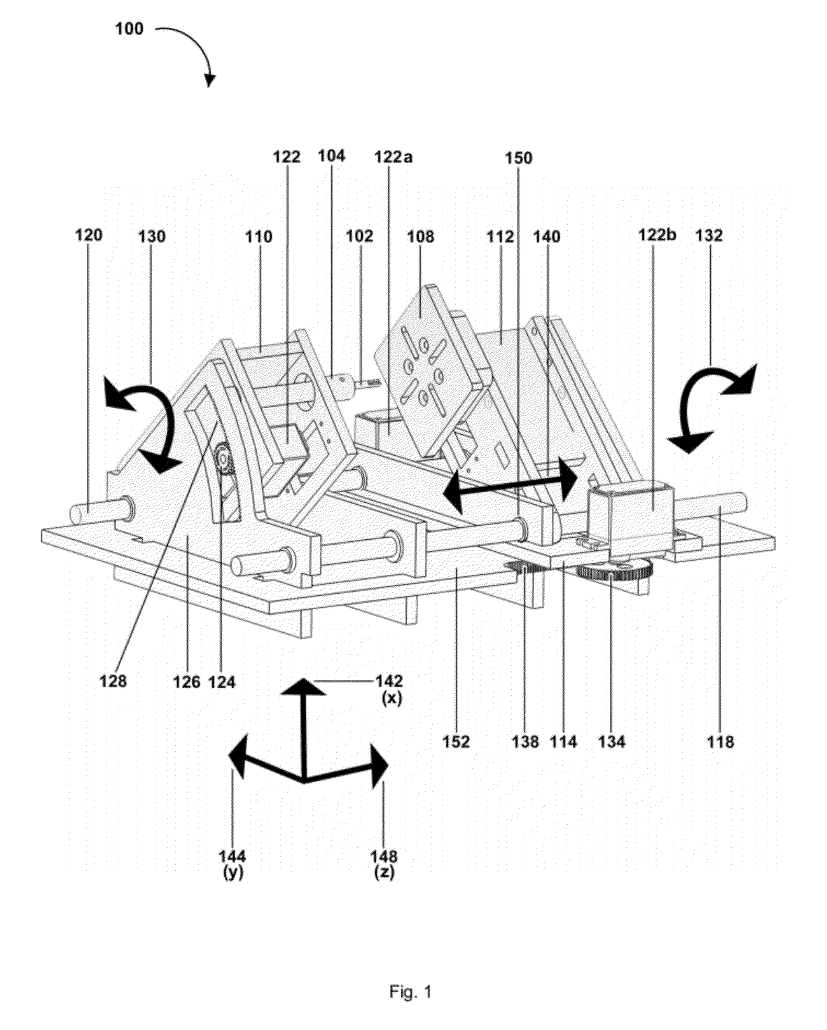

Referring to FIG. 1, one embodiment of the machining mechanism for the CNC three-axis desktop machining center 100 provides a means for motion control for these three axes 142/144/148 by three independent electromechanical systems. Movement in the X-Y plane 142/144 may employ two pivoting structural arms 110/112 that carry respectively a machining head 104 with tool 102 on the left pivot arm 110 and a work stock fixturing table 108 on the right pivot arm 112 wherein their respective arc motions 130/132 intersect one another to create an X-Y swept area of interaction equal to or greater than the X-Y surface area of the preformed work stock to be machined.

In one embodiment, the machining head 104 and its motor drive may be carried on the pivoting structural arm 110 that is positioned by pivot bearings secured to a pivot shaft 120 that permits only angular rotation 130 within the X-Y plane. The positioning of the pivoting structural arm 110 and the machining head 104 with tool 102 may be accomplished by utilizing an electrical motor 122 that will provide angular position control with closed loop feedback. In this embodiment the motor 122a is mounted internally to the pivoting structural arm 110 and is fitted with a spur gear 124 mounted firmly on the output shaft and which spur gear 124 engages a gear rack 128 that is integral to the stationary plate 126 which is an integral part of the chassis. Rotational movement of the motor shaft and integral spur gear 124 moves the pivoting structural arm 110 through an arc about the fixed pivot bearings and pivot shaft 120. The angular motor position may be defined via the algorithms of a computer program and move the machining head 104 relative to the preformed work stock to accomplish the 3-dimensional machined volume described by the computer program.

In one embodiment, the work stock fixturing table 108 and its motor drive may be carried an the pivoting structural arm 112 that is positioned by pivot bearings secured to a pivot shaft 118 that permits only angular rotation 132 within the X-Y plane. The positioning of the pivoting arm 112 and the work stock fixturing table 108 may be accomplished by utilizing an electrical motor that will provide angular position control with closed loop feedback. The Z axis of motion control 148, at right angles to the plane described by the intersecting arcs of the two pivoting structural arms 110/112, may be comprised of a movable platform 114 to which the pivoting structural arm 112 is mounted by linear bushings or bearings 150. Such mounting may permit both the platform 114 and captured pivoting structural arm 112 to move together along 140 using a linear translation guide or set of guides corresponding to the Z axis as constrained by the pair of pivot shafts 118/120 and that motion of the assembly on the Z axis may define the distance between the machining head 104 with tool 102 and the work stock fixturing table 108. In this embodiment the two motors 122a, 122b that position the movable platform 114 are mounted securely to movable platform 114 on either side adjacent to the pivot shafts 118/120. Positioning motor 122b is fitted with a spur gear 134 mounted firmly on the output shaft and which spur gear 134 engages a gear rack 138 that is integral to the stationary base 152, which is in turn an integral part of the chassis of apparatus 100. Rotational movement of the motor shaft and integral spur gear 134 positions the movable platform 114 along the longitudinal axis of the pivot shafts 118/120. The angular motor position may be defined via the algorithms of a computer program and move the pivoting structural arm 112 and the integral work stock fixturing table 108 along the Z axis and relative to the machining head 104 and tool 102 to accomplish the 3-dimensional machined volume described by the computer program.

It will be appreciated by those skilled in the art that the above example is but an illustrative embodiment. The specific recitations of the elements in the above example can be modified to suit particular needs. The orientations and dimensions and compositions of the various components are not strictly limited to those shown in the accompanying drawings or described above, but also extend within the present scope to others that are similar or equivalent or that would be apparent to one skilled in the art upon review of the present disclosure. For example, where a direct drive motor is shown, other drivers may be employed, including indirect drive systems, servos, steppers, piezo systems and others. In addition, where electrical drivers are described, it would be appreciated that hydraulic or pneumatic or other means may be employed to accomplish this end.

In some instances, components that are shown to be separate could be combined. For example, the drivers, motors, groups of linear translators, positioners and such may be modified from those shown or combined by use of reduction gears or articulated joints or a clutch so as to achieve a similar result.

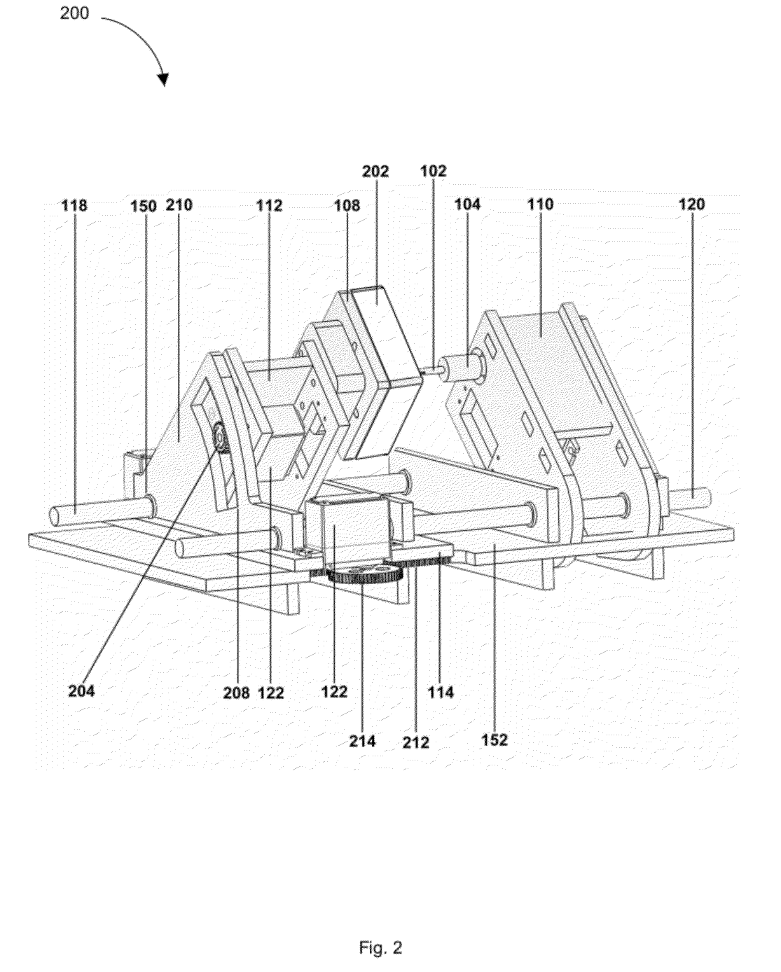

FIG. 2 illustrates and exemplary embodiment of a CNC three-axis desktop machining center 200 that provides motion control for the three axes by three independent electromechanical systems.

Movement in the X-Y plane may employ two pivoting structural arms 110/112 that carry respectively a machining head 104 with tool 102 on the right pivot arm 110 and a work stock fixturing table 108 on the left pivot arm 112 wherein their respective arc motions intersect one another to create an X-Y swept area of interaction equal to or greater than the total surface area of the preformed work stock to be machined.

In one embodiment, the machining head 104 and its motor drive may be carried an the pivoting structural arm 110 that is positioned by pivot bearings secured to a pivot shaft 120 that permits only angular rotation 130 within the X-Y plane. In similar fashion on the opposite hand the work stock fixturing table 108 and the mounted preformed work stock 202 may be carried on the pivoting structural arm 112 that is positioned by pivot bearings secured to a pivot shaft 118 that permits only angular rotation 132 within the X-Y plane. The positioning of the pivoting arm 112 and the work stock fixturing table 108 may be accomplished by utilizing an electrical motor that will provide angular position control with closed loop feedback. In this embodiment the motor 122 is mounted internally to the pivoting structural arm 112 and is fitted with a spur gear 204 mounted firmly on the output shaft and which spur gear 204 engages a gear rack 208 that is integral to the stationary plate 210 which is an integral part of the chassis. Rotational movement of the motor shaft and integral spur gear 204 moves the pivoting structural arm 112 through an arc about the fixed pivot bearings and pivot shaft 118. The angular motor position may be defined via the algorithms of a computer program and move the work stock fixturing table 108 relative to the machining head 104 and tool 102 to accomplish the 3-dimensional machined volume described by the computer program.

The Z axis of motion control, at right angles to the plane described by the intersecting arcs of the two pivoting structural arms 110/112, may be comprised of a movable platform 114 to which the pivoting structural arm 112 is mounted by linear bushings or bearings 150. Such mounting may permit both the platform 114 and captured pivoting structural arm 112 to move together along the Z axis as constrained by the pair of pivot shafts 118/120 and that motion of the assembly on the Z axis may define the distance between the machining head 104 with tool 102 and the work stock fixturing table 108 and the mounted preformed work stock 202. In this embodiment the two motors 122 that position the movable platform 114 are mounted securely to that movable platform 114 on either side adjacent to the pivot shafts 118/120. Each motor 122 is fitted with a spur gear 214 mounted firmly on the output shaft and which spur gear 214 engages a gear rack 212 that is integral to the stationary base 152, which is an integral part of the chassis. Rotational movement of the motor shaft and integral spur gear 214 positions the movable platform 114 along the longitudinal axis of the pivot shafts 118/120. The angular motor position may be defined via the algorithms of a computer program and move the pivoting structural arm 112 and the integral work stock fixturing table 108 and the mounted preformed work stock 202 along the Z axis and relative to the machining head 104 and tool 102 to accomplish the 3-dimensional machined volume described by the computer program.

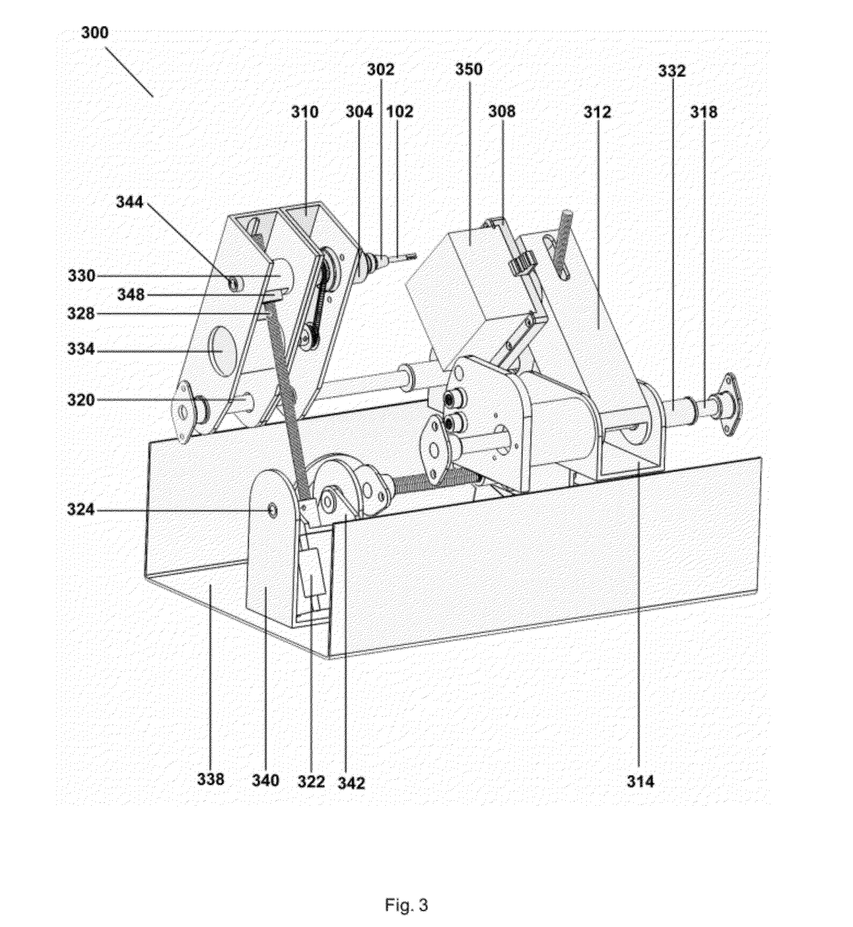

Referring to FIG. 3, one embodiment of the machining mechanism for the CNC three-axis desktop machining center 300 provides a means for motion control for the three axes by three independent electromechanical systems. Movement in the X-Y plane may employ two pivoting structural arms 310/312 that carry respectively a machining head 304 with universal tool holder 302 and tool 102 on the left pivot arm 310 and a work stock fixturing table 308 on the right pivot arm 312 wherein their respective arc motions intersect one another to create an X-Y swept area of interaction equal to or greater than the total surface area of the preformed work stock to be machined.

In one embodiment, the machining head 304 and its motor drive 334 may be mounted to the pivoting structural arm 310 that is positioned by pivot bearings secured to a pivot shaft 320 that permits only angular rotation within the X-Y plane. The positioning of the pivoting arm 310 and the machining head 304 with universal tool holder 302 and tool 102 may be accomplished by utilizing an electrical motor 322 that will provide angular position control with closed loop feedback. In this embodiment the motor 322 is mounted to the chassis 338 by a bracket 340 and positioned in a pivoting 324 sub-frame 342 wherein the output shaft of the motor 322 is fitted with a lead screw 328 that engages a matched nut 348 located on a pivoting sleeve 330 secured to the structural arm by pivot bushings or bearings 344 oriented parallel to the pivot axis of the motor bracket 324. Rotational movement of the motor shaft and integral lead screw 328 within the pivoting nut 348 moves the pivoting structural arm 110 through an arc about the fixed pivot bearings and pivot shaft 320. The angular motor position may be defined via the algorithms of a computer program and move the machining head 304 with universal tool holder 302 and tool 102 relative to the preformed work stock 202 to accomplish the 3-dimensional machined volume described by the computer program.

In one embodiment, the work stock fixturing table 308 and its motor drive may be carried an the pivoting structural arm 112 that is positioned by pivot bearings secured to a pivot shaft 318 that permits only angular rotation within the X-Y plane. The positioning of the pivoting arm 312 and the work stock fixturing table 308 may be accomplished by utilizing an electrical motor that will provide angular position control with closed loop feedback. The Z axis of motion control, at right angles to the plane described by the intersecting arcs of the two pivoting structural arms 110/112, may be comprised of a movable platform 314 to which the pivoting structural arm 312 is mounted by linear bushings or bearings 332. Such mounting may permit both the platform 314 and captured pivoting structural arm 312 to move together along the Z axis as constrained by the pair of pivot shafts 318/320 and that motion of the assembly on the Z axis may define the distance between the machining head 304 with universal tool holder 302 and tool 102 and the work stock fixturing table 308 with the captured preformed work stock 202.

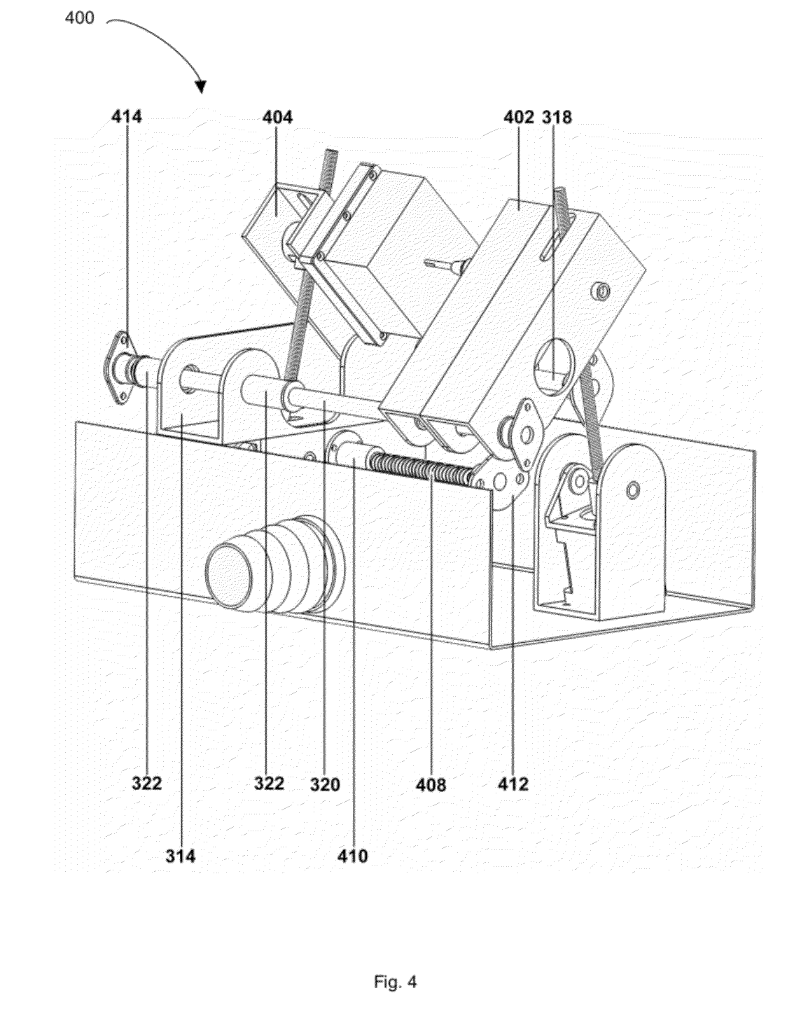

Referring to FIG. 4, one embodiment of the machining mechanism for the CNC three-axis desktop machining center 400 provides a means for motion control for the three axes by three independent electromechanical systems. Movement in the X-Y plane may employ two pivoting structural arm assemblies 402/404 that carry respectively a machining head with universal tool holder and tool on the right pivot arm assembly and a work stock fixturing table on the left pivot arm assembly wherein their respective arc motions intersect one another to create an X-Y swept area of interaction equal to or greater than the total surface area of the preformed work stock to be machined. The Z axis of motion control, at right angles to the plane described by the intersecting arcs of the two pivoting structural arm assemblies 402/404, may be comprised of a movable platform 314 to which the pivoting structural arm assembly 404 is mounted by linear bushings or bearings 332. Such mounting may permit both the movable platform 314 and captured pivoting structural arm assembly 404 to move together along the Z axis as constrained by the pair of pivot shafts 318/320 and that motion of the assembly on the Z axis may define the distance between the machining head and the preformed work stock fixturing table. In this embodiment the motor that positions the movable platform 314 is mounted securely to the chassis in a central position below the movable platform 314 wherein the output shaft of the motor is fitted with a lead screw 408 that engages a matched nut 410 affixed to the movable platform 314. The end of the lead screw 408 is mounted to the chassis by a bearing 412 aligned with the rotational axis of the motor. Rotational movement of the motor shaft and integral lead screw 408 within the nut 348 moves the movable platform 314 along the Z axis along the longitudinal axis of the pivot shafts 318/320. The angular motor position may be defined via the algorithms of a computer program and move the structural arm assembly with the preformed work stock 404 relative to the pivoting structural arm assembly with the machining head 402 to accomplish the 3-dimensional machined volume described by the computer program.

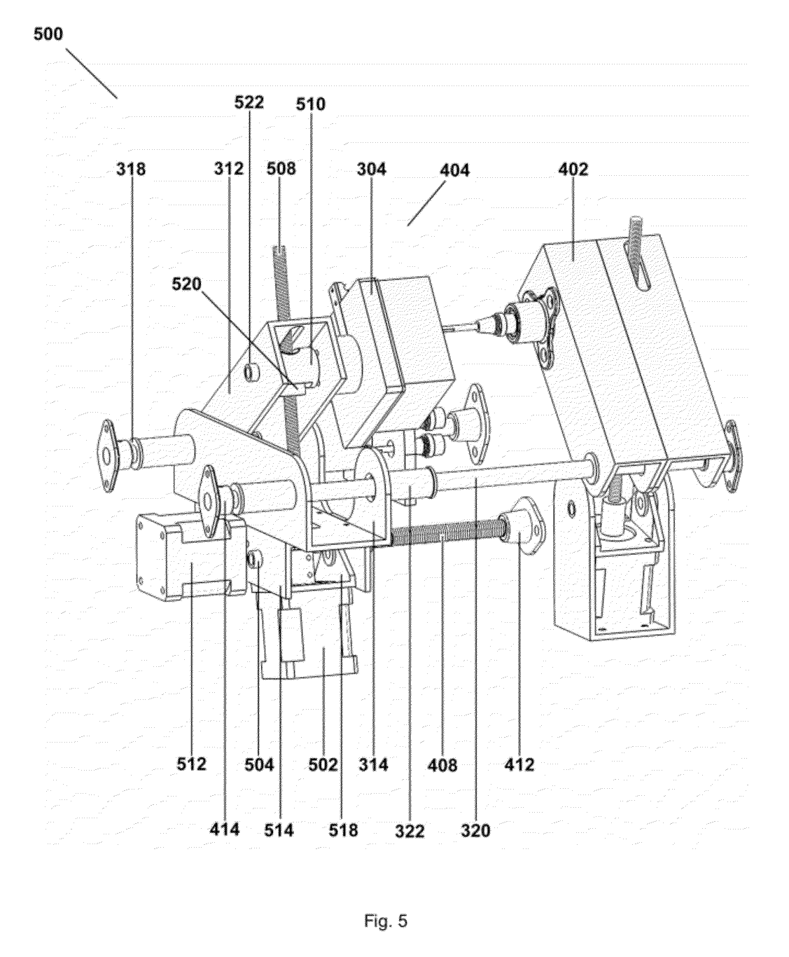

Referring to FIG. 5, which depicts the three axis mechanism without the chassis visible, one embodiment of the machining mechanism for the CNC three-axis desktop machining center 500 provides a means for motion control for the three axes by three independent electromechanical systems. Movement in the X-Y plane may employ two pivoting structural arm assemblies that carry respectively a machining head with universal tool holder and tool on the right pivot arm assembly 402 and a work stock fixturing table on the left pivot arm assembly wherein their respective arc motions intersect one another to create an X-Y swept area of interaction equal to or greater than the total surface area of the preformed work stock to be machined. In one embodiment, the work stock fixturing table 304 may be mounted to the pivoting structural arm 312 that is positioned by pivot bearings secured to a pivot shaft that permits only angular rotation within the X-Y plane. The positioning of the pivoting arm 312 and the work stock fixturing table 304 may be accomplished by utilizing an electrical motor 502 that will provide angular position control with closed loop feedback. In this embodiment the motor 502 is mounted to the movable platform 314 by a bracket 514 that captures a pivoting 504 sub-frame 518 wherein the output shaft of the motor 502 is fitted with a lead screw 508 that engages a matched nut 520 located on a pivoting sleeve 510 secured to the structural arm by pivot bushings or bearings 522 oriented parallel to the pivot axis of the motor bracket 504. Rotational movement of the motor shaft and integral lead screw 508 within the pivoting nut 520 moves the pivoting structural arm 312 through an arc about the fixed pivot bearings and pivot shaft. The angular motor position may be defined via the algorithms of a computer program and move the work stock fixturing table 304 relative to the structural arm assembly with the machining head 402 to accomplish the 3-dimensional machined volume described by the computer program.

The Z axis of motion control, at right angles to the plane described by the intersecting arcs of the two pivoting structural arm assemblies, may be comprised of a movable platform 314 to which the pivoting structural arm assembly is mounted by linear bushings or bearings 332. Such mounting may permit both the movable platform 314 and captured pivoting structural arm assembly 404 to move together along the Z axis as constrained by the pair of pivot shafts 318/320 that are fixed to the chassis by mounting brackets 414 and that motion of the assembly on the Z axis may define the distance between the machining head and the preformed work stock fixturing table. In this embodiment the motor 512 that positions the movable platform 314 is mounted securely to the chassis in a central position below the movable platform 314 wherein the output shaft of the motor is fitted with a lead screw 408 that engages a matched nut 410 affixed to the movable platform 314. The end of the lead screw 408 is mounted to the chassis by a bearing 412 aligned with the rotational axis of the motor. Rotational movement of the motor shaft and integral lead screw 408 within the nut moves the movable platform 314 along the Z axis along the longitudinal axis of the pivot shafts 318/320. The angular motor position may be defined via the algorithms of a computer program and move the structural arm assembly 404 with the preformed work stock relative to the structural arm assembly with the machining head 402 to accomplish the 3-dimensional machined volume described by the computer program.

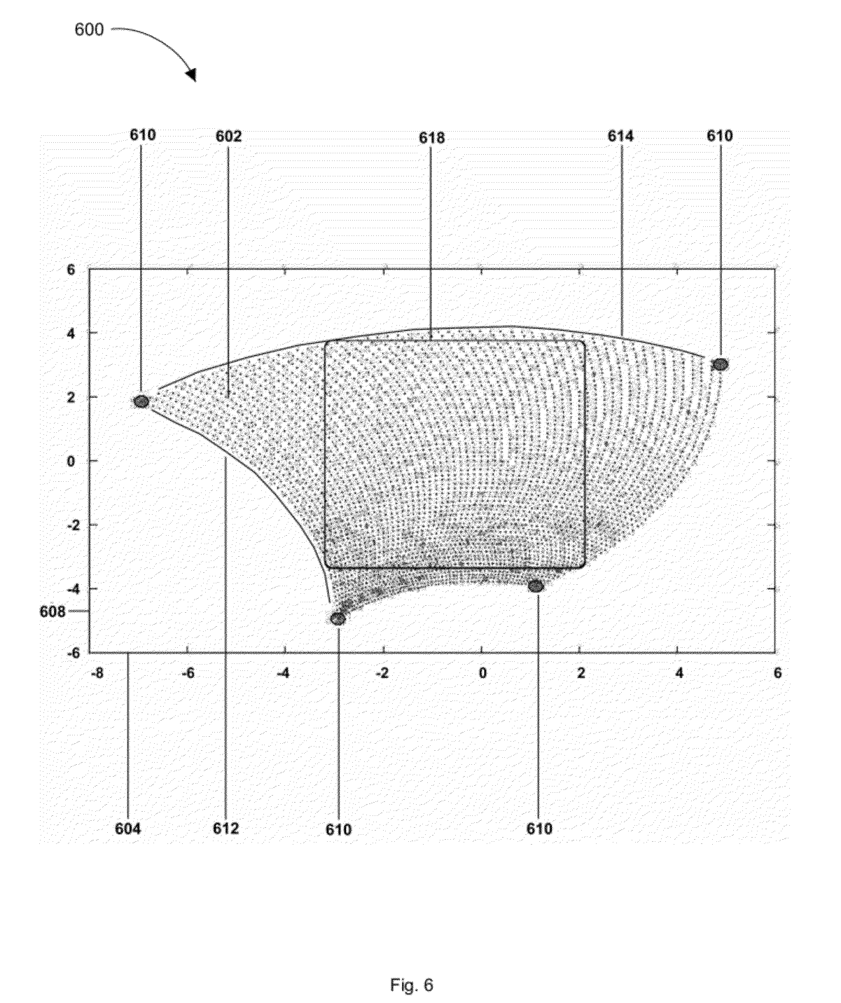

Referring to FIG. 6, the swept area 600 described by the motion of the two arms that comprise the motion control for the X-Y plane produce this plot that displays the sweep matrix 602 in the X axis 604 and the Y axis 608 of the motion of the machining head and tool relative to the motion of the work stock fixturing table and the limits of travel 610 at both ends of the respective arcs of the two pivot arms. The X axis boundary 612 and the Y axis boundary 614 of the workspace are the geometric limits of the mechanical system but the useable workspace 618 for the rectilinear plan form of the preformed work stock must lie wholly within these limits.

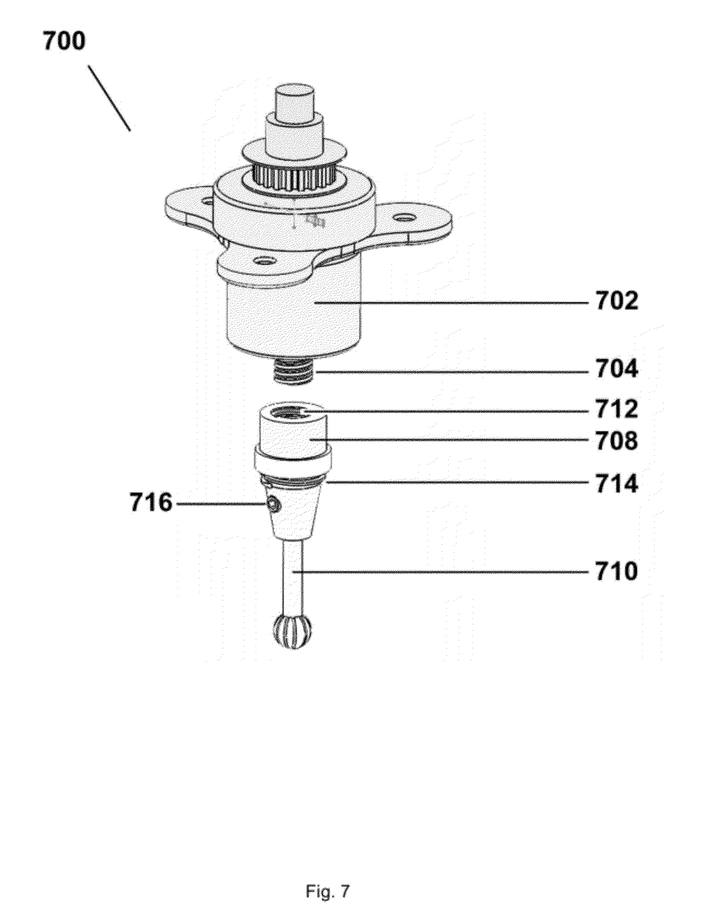

Referring to FIG. 7, the machining head assembly 700 may be comprised of the machining head housing and bearing assembly 702 that is affixed to the pivoting structural arm of the CNC three-axis desktop machining center and interchangeably connects to the various tool assemblies. A tool assembly may consist of the universal tool holder 708 and the tool 710 which may assemble to each other by a close tolerance bore and a tight mating fit of the tool shaft and secured by a clamping screw 716. The universal tool holder 708 may adapt to a wide range of tools that all possess an identical shaft diameter and can be mounted to an identical assembled length. This invention discloses this system of custom designed tools and the universal tool holder to provide simplicity of selection for the user and complete compatibility with the system software and provide consistency and low cost for the range of tools required by the CNC three-axis desktop machining center. The machining head may utilize a right hand thread 704 at the end of the driven spindle to engage a similar thread on the internal diameter 712 of the universal tool holder. Another opposite hand, left hand thread 714 is provided on the external diameter of the universal tool holder that provides engagement into the tool caddy 718 that incorporates a mating left hand thread to engage the outside of the universal tool holder and provide secure axial alignment in the caddy.

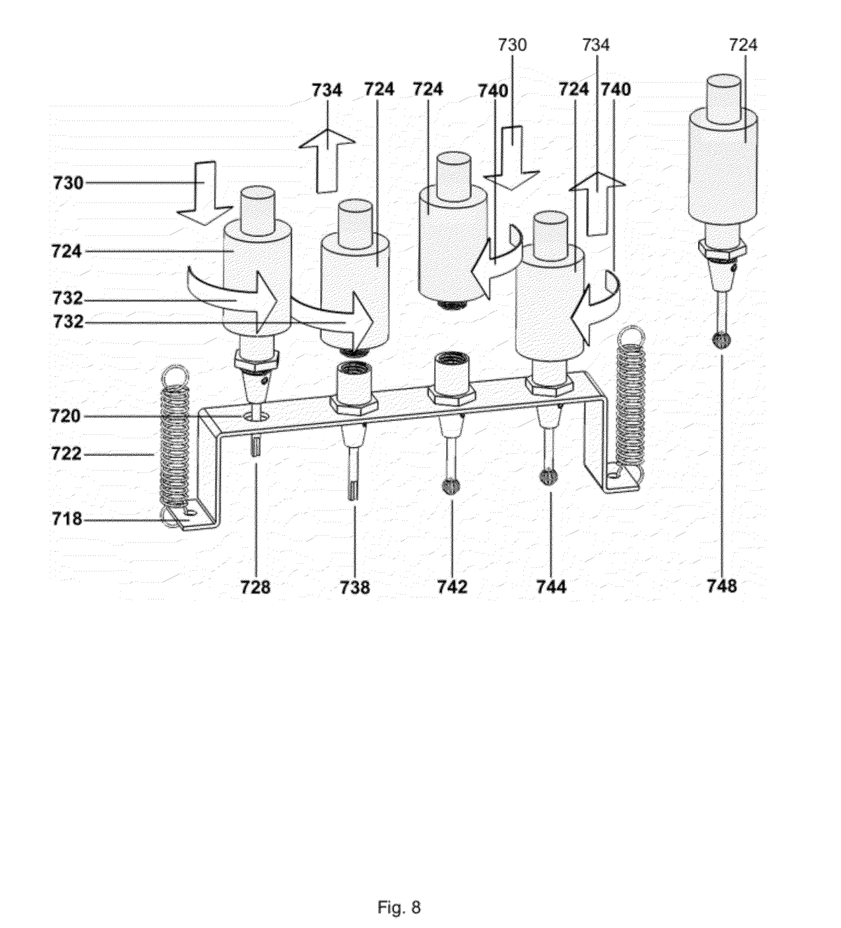

Referring to FIG. 8, the possible sequence of releasing an old tool assembly and securing a new tool assembly to the machining head may consist of four fundamental steps. When the machining head 724 has completed a machining operation and requires a different tool, the computer program will cause the machining head to move to the tool caddy and address the vacant tool receptacle 720 for the current tool 728 in use. The computer software may provide a docking program that will deliver the tool assembly to the docking station of the tool caddy 718. As the machining head 724 and tool assembly approach 730 the docking station with axial alignment, the software may slowly rotate the machining head spindle and tool assembly slowly in a counterclockwise direction 732. As the tool assembly encounters the internal left hand threads of the tool receptacle 720 of the tool caddy the external left hand threads of the universal tool holder engage and are drawn up tight. At the moment of fully seating the tool assembly into the receptacle 738, the left hand motion of the spindle commences to disconnect the right hand thread that engages the spindle to the universal tool holder. As the tool assembly bottoms in the caddy receptacle the machining head and software control, sensing the change in electrical parameters for the driving motor, reverses direction 734 on the axial axis of approach. The compliant mounting 722 of the tool caddy 718 may absorb any mismatch in timing that might create an interference collision of the components of the system. The machining head 724 spindle may continue to slowly rotate in a counterclockwise direction 732 while the right hand thread of the spindle disengages from the internal right hand thread of the universal tool holder 738.

When the machining head 724 and tool assembly have disengaged with the tool assembly the software docking program may move the machining head to an alternative tool assembly receptacle and when axial alignment is achieved 742, the software may slowly rotate the machining head spindle and tool assembly slowly in a clockwise direction 740 and change the direction of the spindle to approach 730 the tool assembly. As the machining head spindle encounters the internal right hand threads of the universal tool holder the threads of the universal tool holder engage and are drawn up tight to the spindle. At the moment of fully seating the tool assembly onto the machining head spindle 744, the right hand motion of the spindle may commence to disconnect the left hand thread that engages the universal tool holder to the receptacle of the tool caddy 718. As the machining head spindle bottoms in the tool assembly the machining head and software control, sensing the change in electrical parameters for the driving motor, reverses direction 734 on the axial axis of approach. The compliant mounting 722 of the tool caddy 718 may absorb any mismatch in timing that might create an interference collision of the components of the system. The machining head 724 spindle may continue to slowly rotate in a clockwise direction 740 while the left hand thread of the universal tool holder disengages from the internal left hand thread of the tool caddy receptacle 748. When the machining head 724 is retracted to the extent that the tool is clear of the tool caddy 718 the CNC three-axis desktop machining center is ready to continue with the next machining operation.

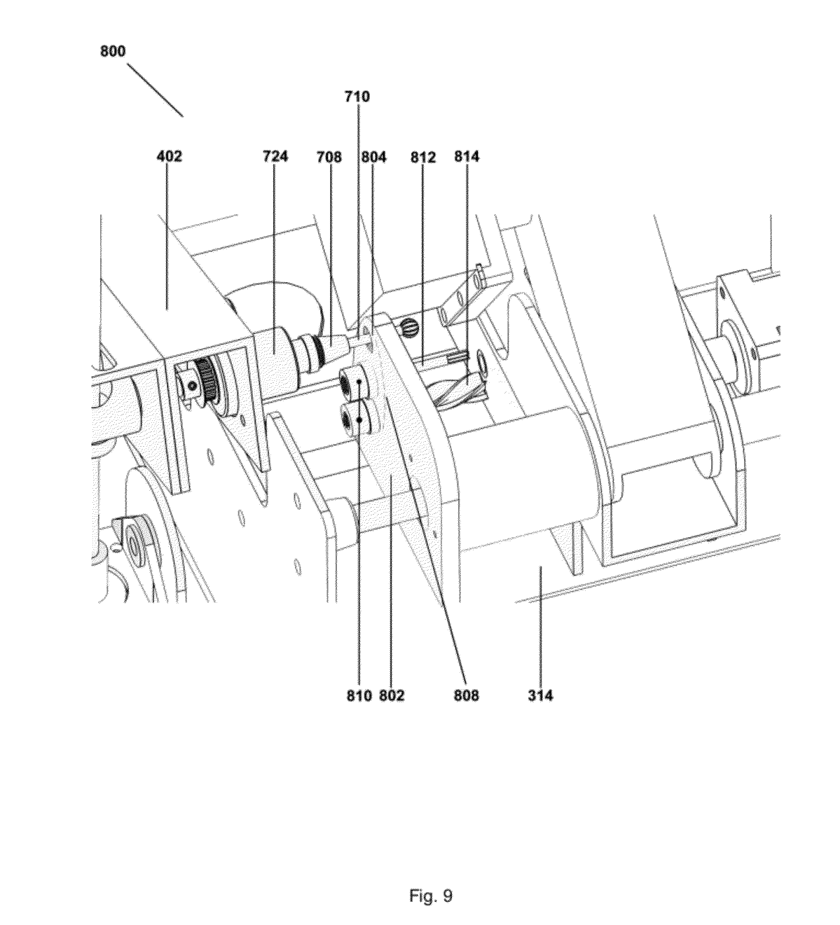

Referring to FIG. 9, in another aspect of this invention the location of the tool caddy system 800 comprises the tool caddy 802 that holds the compliment of tools 710/812/814 required by the software program may be on the movable platform 314 of the CNC three-axis desktop machining center located where it is accessible to the machining head 724 but out of the tool path for machining of the preformed work stock. The tool caddy 802 may also be mounted anywhere on the chassis of the CNC three-axis desktop machining center located where it is accessible to the machining head 724 but out of the tool path for machining of the preformed work stock. The universal tool holder 708 provides a standard interface for the machining head and spindle and a wide range of tools 710/812/814 may be mounted in this single component creating a flexible and simple tooling system. The universal tool holder 708 may have a left hand external thread that engages a similar left hand internal thread on the tool receptacle 804 of the tool caddy 802. The array of tool receptacles 804 are arranged in an arc 808 that mirrors the pivot path of the pivoting structural arm assembly 402 which the machining head assembly 724 is mounted so that controlled motion of only the machining head assembly 724 will provide access to the tool caddy 802 array of tools 710/812/814.

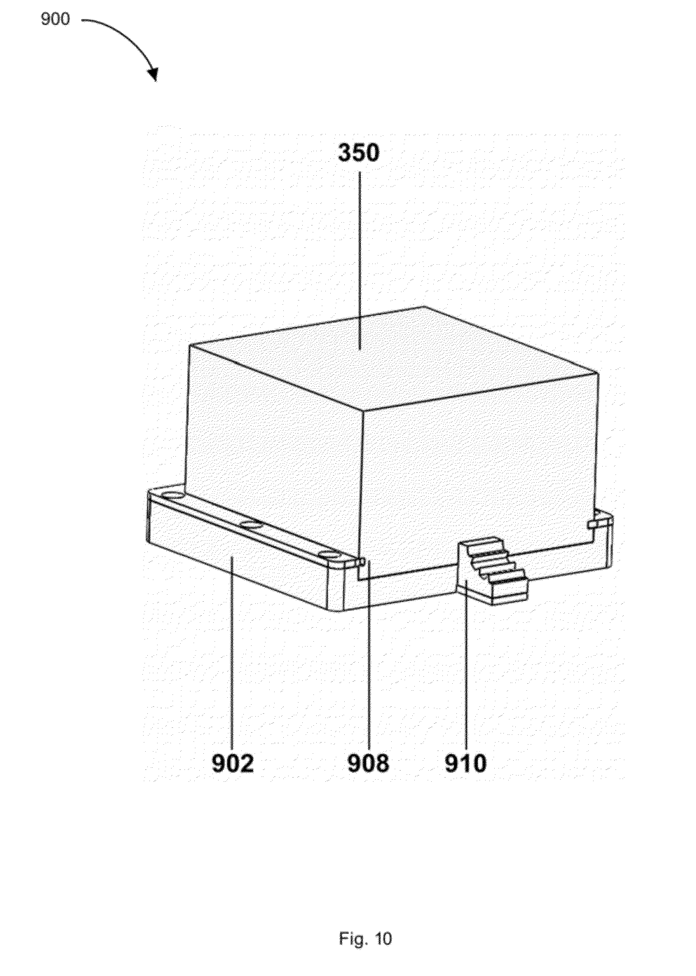

Referring to FIG. 10, in another aspect of this invention the work stock fixturing table assembly 900 may be configured so as to be extremely simple to use providing a locking feature 908/910 for the preformed work stock 350 that requires no tools, measurement, alignment or other fixturing to achieve proper orientation for the preformed work stock relative to the machining head of the CNC three-axis desktop machining center as depicted in the assembled view of the work stock fixturing table 308 with the preformed work stock 350 mounted thereon.

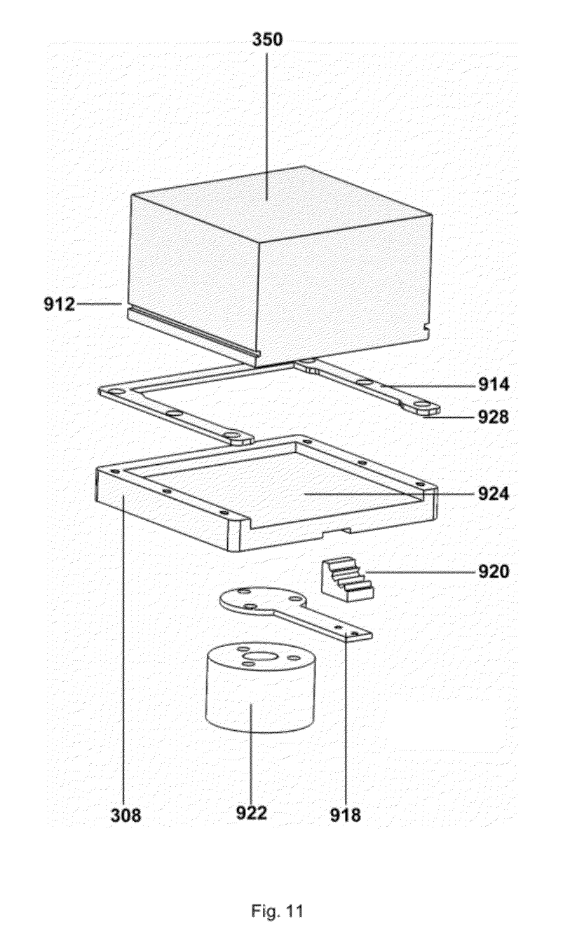

Referring to FIG. 11, the simplicity of the work stock fixturing table 308 is illustrated in the exploded view and is comprised of four fundamental parts. The work stock fixturing table 308 may provide a receptacle 924 with tight tolerances that matches the base dimensions of the preformed work stock 350. Affixed to the top surface of the work stock fixturing table 308 is a perimeter spring clip 914 that engages a close tolerance mating slot 912 in the preformed work stock. The tabs 928 of the spring clip provide a lead-in flare to provide easy engagement to the mating slot 912 of the preformed work stock 350. The remainder of the tab 928 creates a slight interference so that the spring material of the clip provides a downward pressure to tightly register the bottom plane of the preformed work stock 350 to the bottom surface of the work stock fixturing table 308. The preformed work stock 350 may be retained into the receptacle 924 of the work stock fixturing table 308 by a manual spring latch 910 that will flex downward to allow the insertion of the preformed work stock 350. The manual spring latch 910 may be comprised of a spring arm 918 and a finger tab 920. When the preformed work stock is fully seated into the receptacle 924 the manual spring latch 910 will spring back with the finger tab 920 engaging the edge of the preformed work stock 350 so that it is securely retained into the receptacle 924. The work stock fixturing table 308 may be connected to the to the structural pivot arm by a spacer/adapter 922 that enables changes in spacing and orientation of the work stock fixturing table 308.

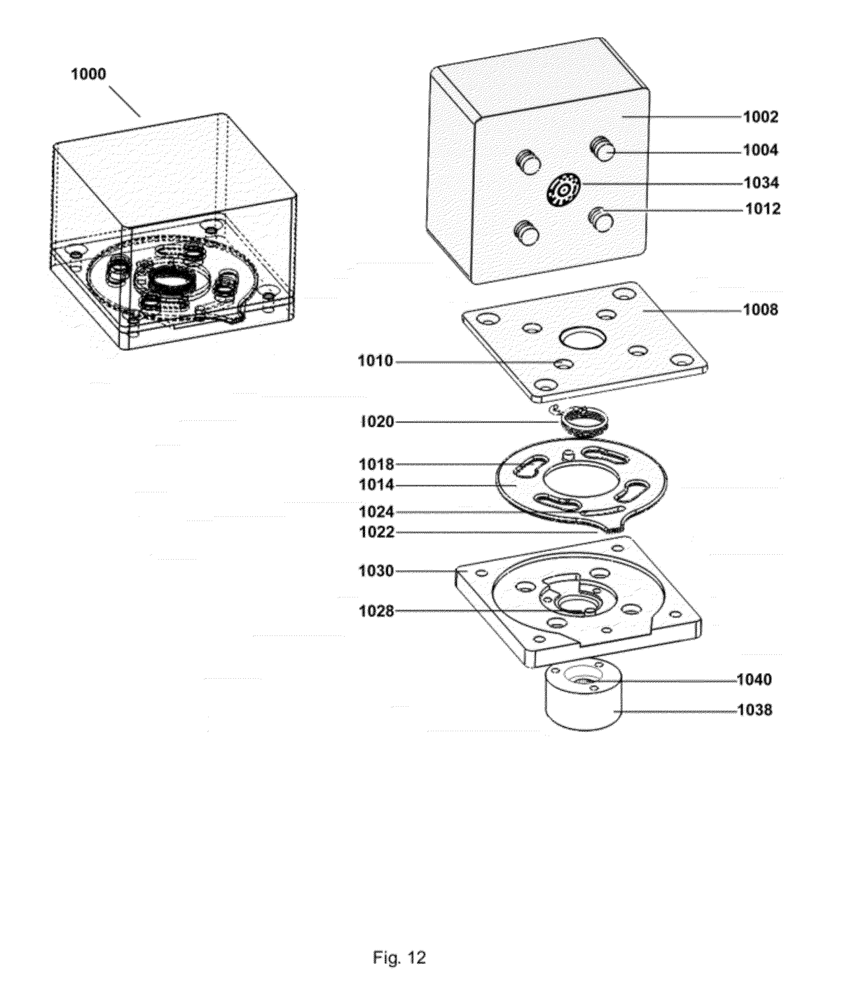

Referring to FIG. 12, in another embodiment of the work stock fixturing table assembly 1000 the table may be configured so as to be extremely simple to use providing a cam plate locking feature for the preformed work stock 1002 that requires no tools, measurement, alignment or other fixturing to achieve proper orientation for the preformed work stock 1002 relative to the machining head of the CNC three-axis desktop machining center as depicted in the assembled view of the work stock fixturing table assembly 1000 with the preformed work stock 1002 mounted thereon. The simplicity of the work stock fixturing table assembly 1000 is illustrated in the exploded view and is comprised of four fundamental components including the work stock fixturing table base plate 1030, the locking cam plate 1014, the torsion spring 1020 and the work stock fixturing table top plate 1008.

The preformed work stock 1002 may have locating and registration pins 1004 integral to the piece that provide for accurate alignment and clamping of the preformed work stock 1002 into the receiving receptacles 1010 of the work stock fixturing table top plate 1008. These locating and registration pins 1004 may have annular grooves 1012 on the cylindrical wall that may provide a capture mechanism to hold the preformed work stock 1002 firmly to the work stock fixturing table assembly 1000. Also, the preformed work stock 1002 may contain encoded identification and machining instructions 1034 and other information that will provide feedback to the system software that will properly configure the machining characteristics of the CNC three-axis desktop machining center.

The work stock fixturing table assembly 1000 may provide an array of receptacle openings 1010 with tight tolerances that matches the dimensions of the of the locating and registration pins 1004 of the preformed work stock 1002. Aligned beneath and axially oriented with the receptacle openings of the work stock fixturing table top plate 1008 are corresponding keyhole shaped openings 1018 in the rotating locking cam plate 1014. These keyhole shaped openings 1018 are configured such that they may receive the locating and registration pins 1004 at the larger end of the keyhole opening which provides clearance for the insertion of the locating and registration pins 1004. When the preformed work stock 1002 is seated firmly against the surface of the work stock fixturing table top plate 1008 manual release of the cam plate latching lever 1022 may allow the torsion spring 1020 to rotate the locking cam plate 1014 such that the narrow end of the keyhole shaped openings 1018 move relative to the locating and registration pins 1004 of the preformed work stock 1002 and engage the annular grooves 1012 on the cylindrical wall of the locating and registration pins 1004 thereby trapping the preformed work stock 1002 into the work stock fixturing table assembly 1000. The narrow end of the keyhole opening 1018 may be configured with a ramp angle that creates downward pressure onto the annular grooves 1012 of the locating and registration pins 1004 as it is rotated thus causing a tight clamping action of the preformed work stock 1002 onto the work stock fixturing table assembly 1000. The rotation of the locking cam plate 1014 may be constrained by a travel limiting keyway 1024 within the plate that engages with a mating pin rigidly mounted to the work stock fixturing table base plate 1030. The assembly of the work stock fixturing table base plate 1030 to the work stock fixturing table top plate 1008 may trap the locking cam plate 1014 and the interconnected torsion spring 1020 between the two components while permitting the constrained rotation of the locking cam plate 1014. The work stock fixturing table assembly 1000 may be connected to the to the structural pivot arm by a spacer/adapter 1038 that enables changes in spacing and orientation of the work stock fixturing table assembly 1000. This spacer/adapter 1038 may contain an electronic/photonic sensor 1040 that will interpret the encoded identification and machining instructions 1034 that will provide feedback to the system software that will properly configure the machining characteristics of the CNC three-axis desktop machining center.

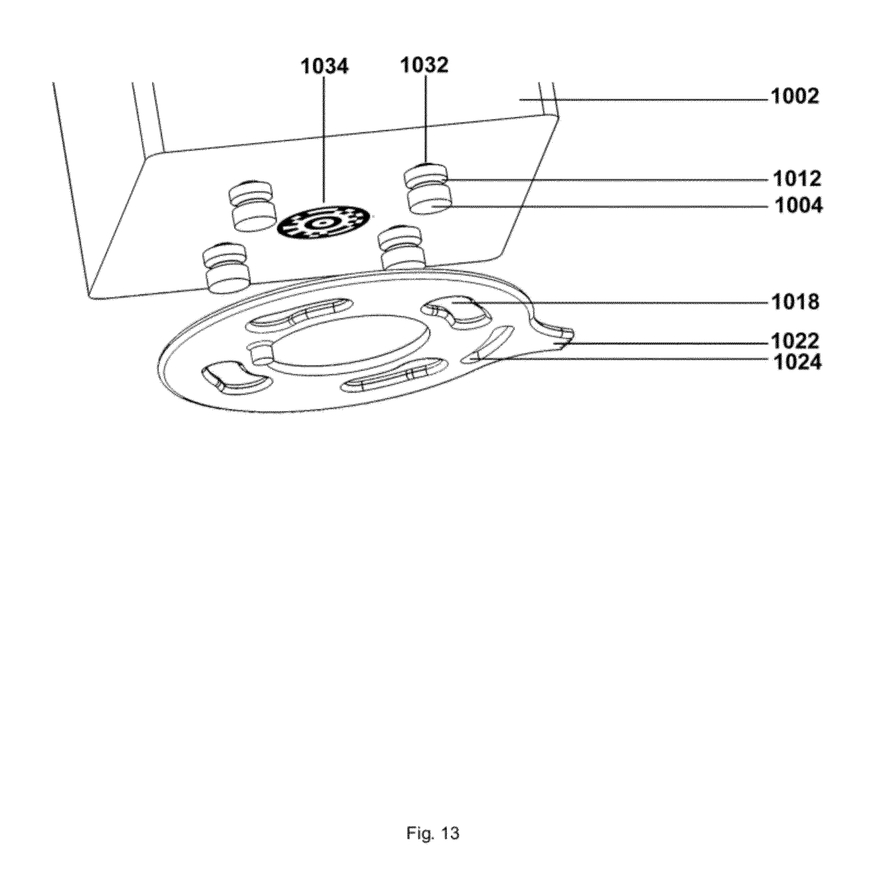

Referring to FIG. 13, in another aspect of this invention, when the preformed work stock 1002 is seated firmly against the surface of the work stock fixturing table and the locating and registration pins 1004 are wholly engaged, the manual release of the cam plate latching lever 1022 may allow the torsion spring 1020 to rotate the locking cam plate 1014 such that the narrow end of the keyhole shaped openings 1018 move relative to the locating and registration pins 1004 of the preformed work stock 1002 and engage the annular grooves 1012 on the cylindrical wall of the locating and registration pins 1004 thereby trapping the preformed work stock 1002 into the work stock fixturing table assembly 1000. The narrow end of the keyhole opening 1018 may be configured with a ramp angle that creates downward pressure onto the annular grooves 1012 of the locating and registration pins 1004 as it is rotated thus causing a tight clamping action of the preformed work stock 1002 onto the work stock fixturing table assembly 1000. The locating and registration pins 1004 may be configured with a basal groove that may be designed such that a sharp sideways impact will create a stress riser at the base of the locating and registration pins 1004 causing a fracture through the base of the locating and registration pins 1004 that shears the pins away from the preformed work stock 1002 permitting the user to easily discard these locating and registration pins 1004 once they have completed their function. Also, the preformed work stock 1002 may contain encoded identification and machining instructions 1034 and other information that will provide feedback to the system software that will properly configure the machining characteristics of the CNC three-axis desktop machining center.

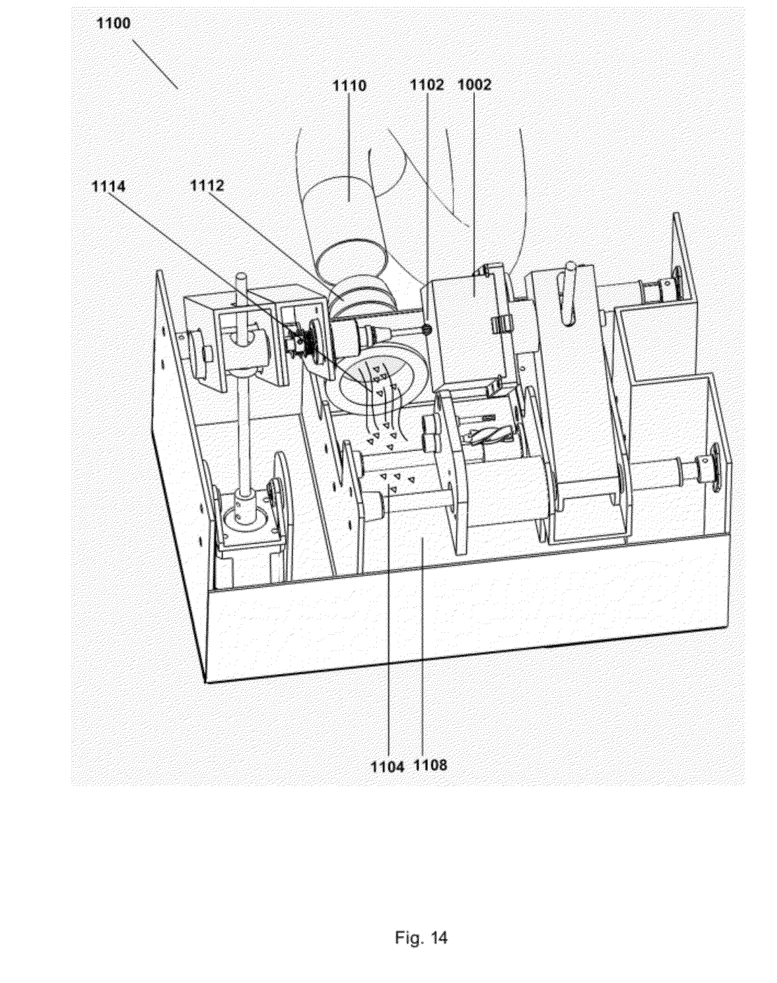

Referring to FIG. 14, in another aspect of the invention the chassis and enclosure 1108 for the mechanical systems may provide safety and cleanliness for the user and environment. The machining process of the tool 1102 removing material from the preformed work stock 1002 creates debris 1104 that may be contained by the chassis and enclosure 1108 for the CNC three-axis desktop machining center so that it does not contaminate the surrounding environment. A vacuum debris removal system 1114 may be implemented that permits the user to attach an external vacuum system 1110 to a universal hose connection port 1112 located to the debris collection chamber of the CNC three-axis desktop machining center such that the debris is continuously removed by the vacuum suction of a standard household vacuum cleaner 1110.

It should be understood that the present concepts regarding the mechanical elements of the present system are not strictly limited to computer controlled systems, but computer control and interface capability provides certain advantages or added features that are known to those skilled in the art.

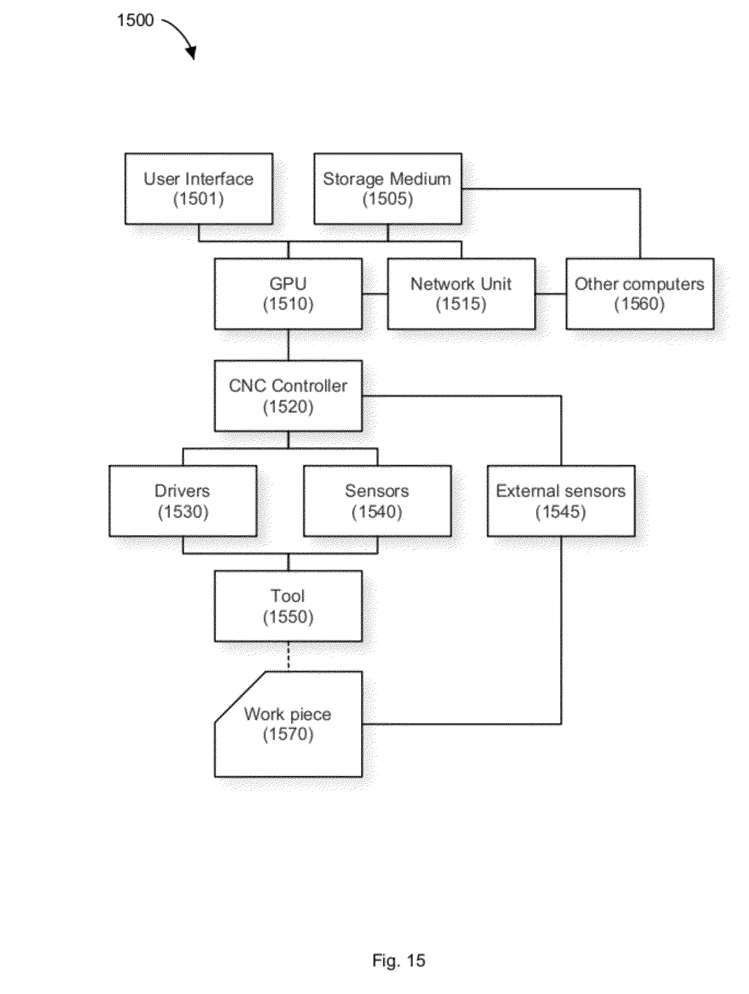

The present disclosure is not intended to be limited by its preferred embodiments, and other embodiments are also comprehended and within its scope. For example, embodiments where the concepts described further comprise an interface to a computer or processor based machine, including a processing circuit and electronic storage (memory) device in which machine readable instructions may be stored and executed. Furthermore, such computer controller or processor capability may further comprise networking features for coupling the present system to other machines or computers over said network. Additionally, co-located or remote user interfaces such as a user front end interface having a visual display can be incorporated herein as illustrated in exemplary FIG. 15. Program instructions may be written, stored and executed to facilitate user interaction with the present machining apparatus or control thereof, including manual (from the console) or automatic operation or even remote operation over said network. Data files can be downloaded or received by the apparatus corresponding to machining instructions to be implemented by the tools of the apparatus on the work piece. Geometric, vector, scalar or other data files and instructions and software modules can be used to form the set of information used to describe the desired result of the machining process on the work piece.

FIG. 15 schematically illustrates an exemplary system 1500 for machining according to the present disclosure. A general processing unit (GPU) 1510 may lie at or near the heart of the system and generally handle inputs and outputs therefrom and may include one or more electronic processing circuits, which may be integrated circuit (IC) types or others. In some embodiments, ordinary computer processors or central processing units (CPUs) or similar circuitry is employed for this purpose as are found in personal computers, laptop computers, servers, network computers, tablet computers or other stationary or mobile electronic devices. In an embodiment, a user operating user interface 1501 connects a port of his or her personal computer, tablet or mobile device to the present machining systems to accomplish personal machining tasks.

A computer numerical control “controller,” or CNC controller module 1520, exchanges information with the GPU 1510 to carry out the machining process. For example, GPU 1510 may provide instructions to CNC Controller 1520, which Controller 1520 converts to control signals delivered to Drivers 1530. Also, input and feedback signals from Sensors 1540 may be used. In some instances, Sensors 1540 are coupled to the Tool 1550 or to the mechanical or electromechanical components of the system. Furthermore, other inputs from External Sensors 1545 may be used to derive signals from other equipment or sensors coupled to the Work Piece 1570, which would be further used in achieving the present operations.

As mentioned earlier, the GPU 1510 may be coupled to other components such as external data bases 1505 and external computers 1560, as well as being capable of including or communicating information with a machine readable storage medium 1505, whether or not co-located with GPU 1510.

Numerous other embodiments, modifications and extensions to the present disclosure are intended to be covered by the scope of the present inventions. This includes implementation details and features that would be apparent to those skilled in the art.

Accordingly, the present invention should not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A system for machining a workpiece, comprising:
a tool mounted to a first moveable arm that moves in a first plane defined by a rotational degree of freedom;
a fixturing table mounted to a second moveable arm that moves in a second plane defined by a rotational degree of freedom; and
a linear translator that translates any of said first or second moveable arms along a translational degree of freedom substantially orthogonal to said first and second planes.

2. The system of claim 1, further comprising a spur gear and gear rack assembly that convert driving torque from a positioning driver to rotational movement of any of said first or second moveable arms.

3. The system of claim 1, further comprising a pair of support frames to which respective ones of the moveable arms are coupled, including a first stationary frame and a second moveable frame that follows a movement of said linear translator.

4. The system of claim 1, further comprising a driver that controllably drives a linear movement of said linear translator.

5. The system of claim 1, further comprising a processor controlled source of control signals that cause respective rotational movements of said first and second moveable arms in said first and second rotational degrees of freedom, and cause linear movement of said linear translator along said linear translational degree of freedom.

6. The system of claim 1, further comprising a tool holder coupled to said first moveable arm.

7. The system of claim 6, said tool holder comprising a universal tool adaptor for accepting one of a plurality of tools with which to machine said workpiece.

8. The system of claim 1, further comprising a waste dispenser that accepts waste material created during use of said system.

9. The system of claim 1, further comprising a set of mechanical registration apertures that align and secure the workpiece with respect to a tool.

10. The system of claim 1, further comprising a machine interface to a processing apparatus, said interface providing control signals generated by the processing apparatus.

11. The system of claim 1, further comprising a set of machine-readable instructions that instruct one or more components of the system so as to achieve programmable computer-controlled operation of the system.

12. A system for machining a workpiece, comprising:
a first moveable arm, coupled to a tool, the first moveable arm also coupled to a first pivot so as to be rotatable about a first axis of rotation;
a second moveable arm, coupled to said workpiece, the second moveable arm also coupled to a second pivot so as to be rotatable about a second axis of rotation, said second axis of rotation being substantially parallel to said first axis of rotation;
respective rotational drivers for said first and second moveable arms controllable so as to rotate said first and second moveable arms with respect to one another and in corresponding substantially parallel planes of motion; and
a linear translator coupled to a driver which moves said linear translator to controllably change a distance between said parallel planes of motion of one or both of said moveable arms.

13. A method in a machining instrument for machining a workpiece, comprising:
preparing a set of machine-readable instructions describing a machining procedure;
providing a plurality of control signals corresponding to said instructions to one or more controllable electro-mechanical components of said machining instrument;
controllably rotating a first moveable arm attached to a machining tool in an arc in a first plane of motion according to some of said control signals;
controllably rotating a second moveable arm attached to the workpiece in an arc in a second plane of motion according to some of said control signals; and
linearly translating at least one of said first and second moveable arms with respect to the other so that a distance between said first and second planes is controlled according to some of said control signals.

14. The method of claim 14, said first and second planes being substantially parallel to one another.

15. The method of claim 14, said linear translation being along a direction substantially orthogonal to one or both of said planes of motion.
